(19) United States
(12) Patent Application Publication
(10) Pub. No.: US 2008/0284203 A1
(43) Pub. Date: Nov. 20, 2008

(54) Drawing-out profile for a window blind

(76) Inventors: Melf Hansen, Gondelsheim (DE); Abdoul Coulibaly, Ostfildern (DE); Werner Schlecht, Vaihingen/Enz (DE)

Correspondence Address: FLYNN THIEL BOUTELL & TANIS, P.C., 2026 RAMBLING ROAD, KALAMAZOO, MI, 49008-1631, US

(21) Appl. No.: 12/152,659

(22) Filed: May 15, 2008

(30) Foreign Application Priority Data
May 16, 2007 (DE) 10 2007 024 250.8

(51) Int. Cl. B60J 1/20

(52) U.S. Cl. 296/152

(57) ABSTRACT

1. Drawing-out profile for a window blind of a vehicle.

2.1. The invention relates to a drawing-out profile (30) for a window blind of a vehicle, with two profile sections (40, 50) which extend in a main direction of extent (2) and can be connected to each other enclosing a preferably flexible sheetlike structure (20) of the window blind, wherein contact surfaces (40a, 50a) of the two profile sections (40, 50) bound an accommodating space for accommodating an end section of the flexible sheetlike structure (20).

2.2. According to the invention, the profile sections (40, 50) can be joined together in a form-fitting or frictional manner via associated connecting means (42, 46, 49, 52, 54, 59).

2.3. Use as a drawing-out profile which can easily be fitted.

3. FIG. 2a.

### FIELD OF APPLICATION AND PRIOR ART

The invention relates to a drawing-out profile for a window blind of a vehicle, with two profile sections which extend in a main direction of extent and can be connected to each other enclosing a preferably flexible sheetlike structure of the window blind, wherein contact surfaces of the two profile sections bound an accommodating space for accommodating an end section of the flexible sheetlike structure.

Drawing-out profiles of the type in question are known from the prior art. They are used for handling window blinds, by means of which windows of a vehicle can be covered for the purpose of protection from prying eyes or the sun. For this purpose, the drawing-out profiles are fastened to the end of the sheetlike structure forming the actual blind and are moved together with said structure when the window blind is transferred from a storage state into a functional state or from the functional state into the storage state. In the storage state, the sheetlike structure is usually stored rolled up in the manner of a roller blind.

The drawing-out profiles known from the prior art are two-part profiles which enclose the end of the sheetlike structure and are connected to each other by ultrasonic welding. With the necessary reliability being maintained, this technique is complicated and expensive, which is considered disadvantageous.

### OBJECT AND SOLUTION

It is therefore the object of the invention to provide a drawing-out profile which can be produced at reasonable cost and is simple to fit. Furthermore, it is the object to provide a shading system with an improved drawing-out profile of this type.

This object is achieved in that the profile sections can be joined together in a form-fitting or frictional manner via associated connecting means. The profile sections are preferably of approximately the same size, in particular of approximately the same length in a main direction of extent. However, their length may also differ to a limited extent. In particular, one of the profile sections may be designed to be a small extent longer such that said profile section forms both of the ends of the drawing-out profile. This makes it possible to avoid aesthetically disadvantageous joining channels being readily visible between the profile sections in the region of the ends of the drawing-out profile. Within the context of this invention, the connecting means of the profile sections are sections which are each assigned to one of the profile sections and which are designed for interaction with each other. In this case, connecting means of the one profile section interact with connecting means of the other profile section in such a manner that a coupling of the two profile sections is produced. The connecting means can be connected directly to the profile section assigned in each case to them or can be connected to said profile section during the course of the installation. By means of the connecting means, a drawing-out profile according to the invention can be composed of the two profile sections which, in this case, define, by means of their respective contact surfaces, an accommodating space in which the flexible sheetlike structure can be accommodated. In the joined-together state, the profile sections are preferably spaced apart from each other in the region of the contact surfaces such that the flexible sheetlike structure is present in a manner such that it is pressed into the accommodating space and therefore a frictional connection is produced between the profile sections and the sheetlike structure.

The frictional and form-fitting connecting means significantly simplify the installation process and lead to low production costs. Furthermore, the quality deficiencies which are not uncommon in this region and can be attributed to the ultrasonic welding are avoided. In order to obtain a particularly secure connection between the profile sections, the profile sections preferably have connecting means which either extend over a considerable part in the main direction of extent, or which comprise a multiplicity of individual connecting elements which are arranged distributed over the length of the profile sections.

Drawing-out profiles are particularly preferred, in which the connecting means comprise hinge connecting means, by means of which the profile sections can be joined together during installation of the drawing-out profile in such a manner that they can be pivoted in relation to each other about a pivot axis preferably extending in the main direction of extent. The hinge connecting means are designed in such a manner that the separate profile sections can be joined together producing the hinge function. In the simplest case, a hinge function of this type can be obtained by a groove which is open on one side being provided on one of the profile sections and into which a corresponding web of the other profile section can be pushed. Hinge connecting means are to be understood in conjunction with this invention as also meaning connecting means in which, in order to maintain the hinge function, the profile sections have to be held or pressed together in a certain manner. It is accordingly not required for the hinge connecting means, in the assembled state, to be able to prevent a separation of the profile sections from each other. The effect achieved by the hinge connecting means and the pivotability of the profile sections with respect to each other, which pivotability is produced in the joined-together state, is that the profile sections are in a defined position with respect to each other such that a subsequent installation step, in which the profile sections, when folded onto each other, are connected to each other by further connecting means, can be carried out without it being furthermore necessary to orient the profile sections with respect to each other. In preferred embodiments, in the fitted state, the hinge connecting means additionally form a holding means which prevents separation of the profile sections in a direction orthogonal to the contact surfaces.

As an alternative to the hinge connecting means according to this development, embodiments in which the two profile sections are connected integrally to each other via a film hinge are also covered by the invention.

In a development of the invention, the connecting means have orthogonal connecting means which, by pressing the profile sections together in a direction orthogonal to the contact surfaces, can be transferred into a connected state. The contact surfaces of the profile sections do not absolutely have to be completely flat, and therefore a direction which is oriented orthogonally to the contact surfaces is to be understood within the context of said invention as meaning a direction which is oriented approximately orthogonally to those sections of the contact surfaces which, in turn, are oriented essentially parallel to the sheetlike structure in its functional state. The orthogonal connecting means can be connected to each other by simple pressing of the profile sections together. In the simplest case, this involves cylindrical plug-in sections on one of the profile sections and a corresponding recess on the other profile section such that a frictional connection can be created with a press fit being formed. The connection of the profile sections via orthogonal connecting means is particularly advantageous in those drawing-out profiles in which hinge connecting means are also provided. In this case, the hinge connecting means can initially serve to ensure a desired relative position of the profile sections with respect to each other such that subsequently the profile sections can be pivoted with respect to each other until they are brought by the orthogonal connecting means into a state in which they are fixedly joined together. This design with hinge connecting means and orthogonal connecting means is advantageous with regard to easy and rapid fitability.

In a development of the invention, the orthogonal connecting means comprise on one of the profile sections a latching lug and on the other profile section a latching threshold, the latching lug being elastically deflectable during the course of the pressing-together operation such that it can latch behind the latching threshold. A configuration with a plurality of latching lugs and latching thresholds is advantageous, with the latching lugs preferably being designed to deflect in various directions during the latching operation. The connection of the profile sections via latching lugs and latching thresholds or via other latching means constitutes a simple and cost-effective form of the design. In particular, it is ensured by means of latching that, because of their form-fitting latching coupling, the profile sections, when used correctly, no longer become detached from each other.

In a preferred embodiment, the latching lug is arranged and designed in such a manner that it is elastically deflected by the latching threshold in the direction or counter to the direction of the hinge connecting means during the course of the pressing-together operation. A latching lug of this type is accordingly arranged and designed in such a manner that, together with the hinge connecting means, it can effectively oppose a relative displacement of the profile sections in relation to each other in the plane of the contact surfaces.

In a particularly preferred embodiment, the orthogonal connecting means have on one of the profile sections a cylindrical section which extends in the direction of a surface normal of the contact surface of the profile section with the other profile section, and on the other profile section a clamping section with at least two deflectable clamping tongues which are directed towards each other and are arranged and designed in such a manner that an accommodating space, the cross section of which is smaller than the cross section of the cylindrical section, is formed between the clamping tongues in an undeflected state. The profile sections are preferably designed with a plurality of such cylindrical sections and a plurality of clamping sections. The cylindrical section preferably has a round cross section, but may also have a different cross-sectional shape, for example the shape of a polygon. The cross-sectional area is dimensioned in such a manner that the cylindrical section, upon insertion between the clamping tongues, deflects the latter such that the clamping tongues are pressed against a circumferential surface of the cylindrical section during further pushing-in of the cylindrical section. It is particularly advantageous if the clamping tongues are composed of a material which is harder than the cylindrical section such that they press to a limited extent into the cylindrical section and thereby carry out a type of barb function. In a particularly preferred design, the clamping section is of metallic design and is connected to a profile section which is assigned to it and is composed of plastic.

In a development of the invention, the drawing-out profile has sliding-guide connecting means which permit the one profile section to be pushed into the other profile section in the plane of the contact surfaces, the sliding-guide connecting means preferably being designed in such a manner that they form a press fit in the pushed-in state, the press fit opposing a detachment of the profile sections from each other. In this development, the sliding-guide connecting means are designed in such a manner that the one profile section can be fitted onto the other profile section and then a relative displacement is carried out in the plane of the contact surfaces, by means of which the profile sections are pushed one inside the other. A design in which the profile sections are dimensioned such that a press fit comes about permits, depending on the embodiment, further connecting means to be dispensed with.

In one variant of a drawing-out profile with sliding-guide connecting means, the sliding-guide connecting means are designed in such a manner that one of the profile sections can be pushed into the other profile section in a pushing-in direction which differs from the main extent, preferably in a pushing-in direction which is orthogonal to the main direction of extent. In such a configuration, the profile sections are preferably displaced in relation to each other over their short side and therefore orthogonally to the main direction of extent such that the pushing-in distance is comparatively short. This facilitates the installation. One configuration of a drawing-out profile of this type firstly has two receptacles which are open in the pushing-in direction or counter to the pushing-in direction and are spaced apart from each other in the pushing-in direction. Secondly, such an embodiment has two insertion sections for accommodating in the receptacles. In the case of a design of this type, the profile sections, for joining them together, are first of all placed on each other such that in each case one insertion section is arranged in the region of the open side of one receptacle. The profile sections are then displaced in relation to each other in such a manner that the two insertion sections are pressed into the receptacles. This produces a connection between the profile sections, which connection can essentially be released again only by displacement of the profile sections counter to their pushing-in direction. Particularly good support is achieved if the receptacles and the insertion sections extend in the form of grooves and insertion webs over the entire length or approximately the entire length of the profile sections. Embodiments in which the receptacles are provided on one of the profile sections and are designed such that they are open in the same direction while the insertion sections are provided on the other profile section are particularly preferred.

An alternative embodiment of a drawing-out profile with sliding-guide connecting means makes provision for the latter to be designed in such a manner that one of the profile sections can be pushed in the main direction of extent into the other profile section. In the case of this configuration, the sliding-guide connecting means preferably extend over the entire length or approximately the entire length of the profile sections. The sliding-guide connecting means are designed such that they are open at their end at least on one of the profile sections such that the other profile section can be pushed in at this point. Said profile section can then be displaced in the main direction of extent over the entire length of the profile section designed with the open sliding-guide connecting means until the profile sections lie approximately congruently one above the other. A particular advantage of the configuration of the profile sections with sliding-guide connecting means which permit a profile section to be pushed in in the main direction of extent is that a particularly stable support of the profile sections on each other is ensured, since, in the preferred embodiment, the connecting means extend continuously over the entire length of the profile sections.

A development makes provision for the sliding-guide connecting means to have on one of the profile sections two grooves which extend in the main direction of extent and the open sides of which point in opposite directions and for engagement sections for accommodating in the grooves to be provided on the other profile section. The grooves on the one profile section are preferably designed in such a manner that their open sides point towards each other. In a manner corresponding thereto, the engagement sections on the other profile section are formed in a direction pointing away from each other. Both the opening direction of the grooves and the direction of extent of the engagement sections preferably extend parallel to the plane of the contact surfaces. The design with two grooves on one of the profile sections and two engagement sections on the other profile section can be produced at reasonable cost and is advantageous for use.

In a variant thereof, the grooves and the engagement sections each have at least two groove sections or engagement sections which are aligned with each other, with there being a respective spacing between the groove sections in the main direction of extent, the length of which spacing is greater than or equal to the length of the engagement sections. In such a configuration, the grooves and the engagement sections are configured in such a manner that they alternate in the main direction of extent with spacings in which no groove sections and no engagement sections are provided. This configuration permits the profile sections to be pushed one inside another in the main direction of extent without the profile sections having to be displaced in relation to each other over their entire length for this purpose. Instead, the engagement sections can be placed in the region of the spacing between groove sections and can then be pushed into the groove sections. In the case of profile sections with, for example, three groove sections per groove, for the joining-together operation the displacement direction of the profile sections can be reduced approximately to one third of the entire length of the profile sections.

In a development of the invention, the sliding-guide connecting means have on one of the profile sections a locking recess which is open in the direction of the other profile section, and on the other profile section a locking section for accommodating in the locking recess. In this case, the locking recess and the locking section are arranged in such a manner that the locking section can latch into the locking recess as soon as the one profile section is fully pushed into the other profile section. The design of a drawing-out profile with sliding-guide connecting means and with the use of a locking recess and a locking section permits an additional support to be obtained between the profile sections in the final position with regard to the pushing-in operation. In this case, the locking recess and locking section are preferably designed in such a manner that the locking section can engage in the locking recess in a direction orthogonal to the contact surfaces. In order for this to be achieved, the locking section is dimensioned in such a manner that it brings about an elastic deformation of one or both profile sections prior to the snapping into the locking recess during the pushing of the profile sections one inside the other. Only when it passes into the region of the locking recess and is snapped therein does said elastic deformation cease.

In a development of the invention, at least one part of the connecting means is connected integrally to the associated profile section. This particularly simple configuration is particularly advantageous with regard to economical manufacturing. Depending on the configuration of the drawing-out profile, all of the connecting means can each be connected integrally to the profile section assigned to them.

In a particular embodiment of a drawing-out profile according to the invention, at least one part of the connecting means is provided on at least one separate connecting section, the separate connecting section being designed such that it can be connected to the profile section assigned to said part of the connecting means. In such a configuration, individual connecting means are not provided directly integrally on the profile section assigned to them but rather can be connected thereto before the profile section is connected to the other profile section. This design with one separate connecting section or a plurality of such connecting sections firstly permits the use of geometries which cannot be produced integrally with the customarily used plastic manufacturing methods or are expensive. Secondly, the design of individual connecting means on separate connecting sections gives rise to the possibility of using different materials, with preferred embodiments in particular making provision for the separate connecting sections and the connecting means provided on them to be metallic while the profile sections themselves are composed of plastic. The combination of these different materials permits the production of lightweight drawing-out profiles, the profile sections of which are connected particularly firmly to each other.

The design with a separate, preferably metallic, connecting section in orthogonal connecting means with a clamping section having deflectable clamping tongues which are provided for interaction with a cylindrical section on the opposite profile section is particularly advantageous. In the case of said orthogonal connecting means, the effect which can be achieved by the metallic design of the clamping tongues is that the clamping tongues can advantageously press into the cylinder section, which is composed of plastic, thus resulting in a connection of the profile sections that is scarcely still releasable without destruction under normal operating conditions.

The separate connecting section can preferably be fastened to the associated profile section by a sliding guide, the sliding guide being able to-be designed in such a manner that the connecting section can be pushed into the profile section in the plane of the contact surfaces and orthogonally to the main direction of extent. The sliding guide is preferably designed in such a manner that the connecting section, in the pushed-in state, forms a press fit with the sliding guide, the press fit opposing a sliding-out of the connecting section. In a particularly preferred configuration, the sliding guide has, on sides of the profile section, accommodating grooves into which webs of the connecting section are pushed. A particularly advantageous configuration in order to obtain a press fit makes provision for the webs of the connecting section, which webs are inserted into the grooves on the profile-section side, to be elastically deformable with regard to their thickness, for example by means of a configuration as a slightly bent sheet-metal part.

Drawing-out profiles, in which the contact surfaces are shaped in such a manner that the cross section of the accommodating space, which is arranged between them, for the sheetlike structure has at least one change in direction, preferably two or more changes in direction, with the changes in direction being more than 45°, preferably 90° or more, are particularly preferred. One such design of the contact surfaces leads to the accommodating space forming a labyrinth guide into which the sheetlike structure can be placed. This constitutes an effective protection against the sheetlike structure slipping out of the accommodating space. Embodiments which have a plurality of changes in direction which preferably run in different directions are particularly preferred. A design of the accommodating space with a groove which is provided on one profile section and into which the sheetlike structure is pressed by means of a web provided on the other profile section is also advantageous.

In a development of the invention, penetrating sections which extend into the accommodating space for the sheetlike structure are provided on at least one of the profile sections. Said penetrating sections are preferably of elongate design, for example in the form of penetrating pins or penetrating tips. Depending on the type of sheetlike structure used, it is advantageous if the penetrating sections are of sharp-edged design in order to be able to penetrate the sheetlike structure. The penetrating sections therefore provide additional support against the sheetlike structure slipping out of the drawing-out profile. The use of penetrating sections in a textile sheetlike structure, in which the penetrating pins can penetrate the knit or fabric, is particularly preferred. The penetrating sections are preferably formed integrally with the associated profile section, but may also be provided as separate components.

The invention furthermore comprises a shading system, comprising a sheetlike structure and a drawing-out profile of the above-described type, wherein the drawing-out profile is connected fixedly to the sheetlike structure at the end thereof by enclosing the sheetlike structure. In this case, it is particularly advantageous if the sheetlike structure has recesses in the region of connecting means of the drawing-out profile. Such recesses permit connecting means of both profile sections to be connected directly to each other without the sheetlike structure being arranged in the connecting region between them. Recesses according to the invention are expedient in particular in the region of orthogonal connecting means. It is advantageous if the recesses are surrounded on all sides by the sheetlike structure such that they constitute an additional protection against the sheetlike structure slipping out of the drawing-out profile.

In a particularly preferred embodiment, the sheetlike structure is connected to one of the profile sections with a cohesive material joint, preferably by means of an adhesive connection or a welding connection. Such a connection of the sheetlike structure to one of the profile sections with a cohesive material joint firstly has the effect of making it more difficult for the sheetlike structure to slip out of the drawing-out profile. Secondly, however, such a connection with a cohesive material joint is advantageous during the installation. In the case of an advantageous installation procedure, it is thus provided that the sheetlike structure is first of all connected to one of the profile sections with a cohesive material joint such that it is in a defined position when said profile section is connected to the other profile section by means of the connecting means.

### BRIEF DESCRIPTION OF THE DRAWINGS

Further advantages and features of the invention emerge from the claims and from the description below of preferred exemplary embodiments of the invention, which are illustrated with reference to the drawings, in which:

FIG. 1 shows a shading system according to the invention in its fitted situation in a vehicle door,

FIGS. 2a, 2b show a first embodiment of a drawing-out profile according to the invention,

FIGS. 3a, 3b show a second embodiment of a drawing-out profile according to the invention,

FIGS. 4a, 4b show a third embodiment of a drawing-out profile according to the invention,

FIGS. 5a, 5b show a fourth embodiment of a drawing-out profile according to the invention, and

FIGS. 6a, 6b show a fifth embodiment of a drawing-out profile according to the invention.

### DETAILED DESCRIPTION OF THE EXEMPLARY EMBODIMENTS

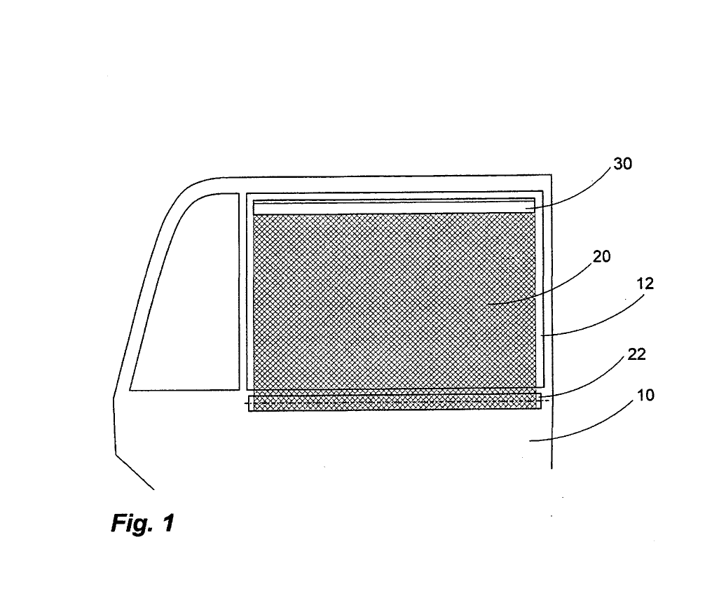

FIG. 1 shows a shading system according to the invention which is used in a vehicle door 10 of a vehicle in order to act as a sunblind for a vehicle window 12. The shading system has a flexible sheetlike structure 20 which, in a storage state (not illustrated), is rolled up on a roller blind shaft 22. In the functional state illustrated, the sheetlike structure 20 is unrolled upward from the roller blind shaft. A dimensionally stable drawing-out profile 30 is provided at the upper end of the sheetlike structure 20. Said drawing-out profile 30 gives the flexible sheetlike structure its shape and permits easy manual handling of the shading system. The drawing-out profile 30 can be designed in different ways.

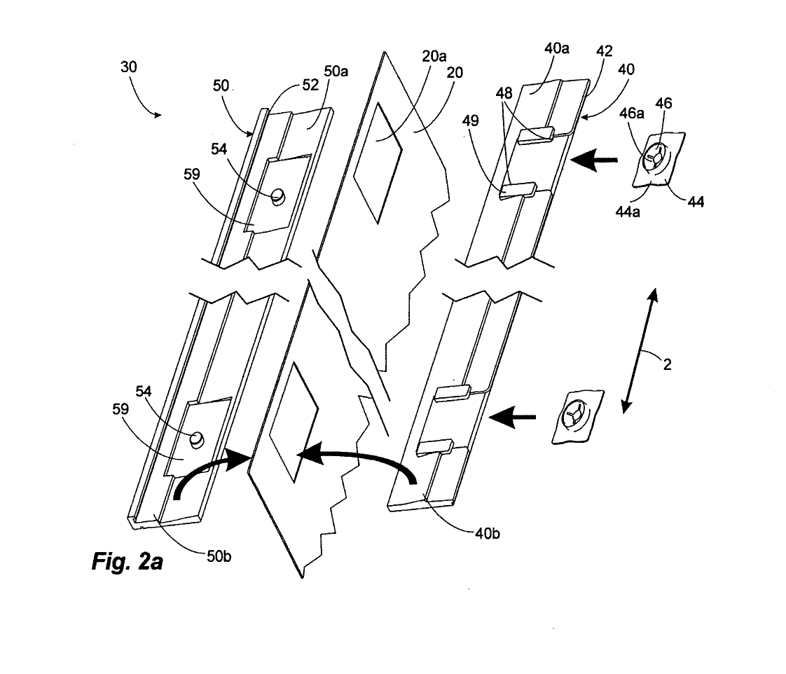

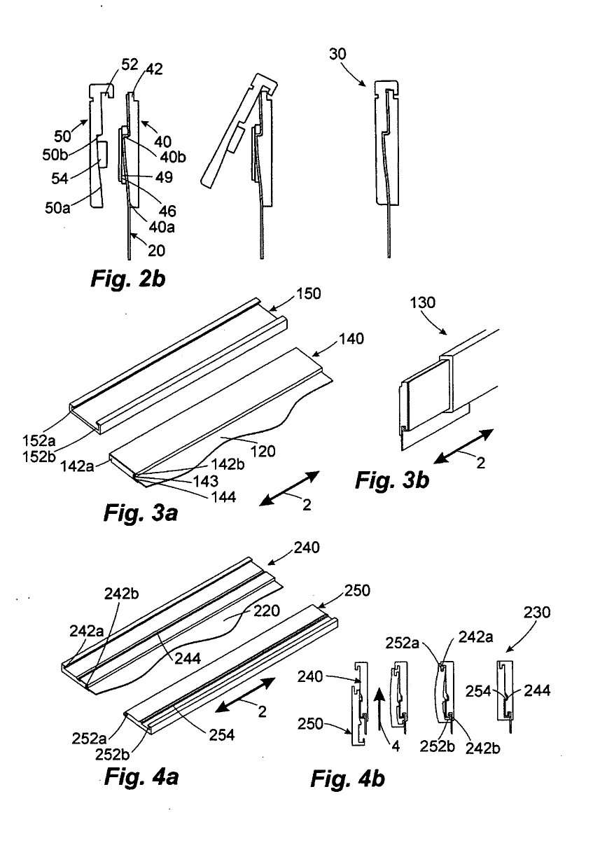

FIGS. 2 to 6 show various drawing-out profiles 30, 130, 230, 330, 430. They differ particularly in the type of connecting means by means of which the profile sections of the drawing-out profiles are connected to each other.

The drawing-out profile 30 which is illustrated in FIG. 2a has two profile sections 40, 50 which are both manufactured from plastic. These profile sections 40, 50 each have a clamping surface 40a, 50a, said clamping surfaces being provided in order, in an assembled state of the profile sections 40, 50, to bear on both sides against an upper end of the sheetlike structure 20 and to thereby clamp the latter firmly between the profile sections 40, 50. A respective threshold 40b, 50b is provided in the region of the clamping surfaces 40a, 50a in order for the sheetlike structure 20 to be deflected on said threshold. To connect the profile sections 40, 50 to each other, a series of connecting means is provided. A groove 52 which extends over the entire length and opens in the plane and in the direction of the clamping surface 50a is thus provided on the profile section 50. In a manner corresponding thereto, an insertion web 42 which likewise extends over the entire length is provided on the profile section 40. Furthermore, a plurality of cylinder sections 54 are provided on the profile section 50, said cylinder sections extending from the profile section 50 approximately in a direction orthogonal to the contact surface 50a. The cylinder sections 54 are each arranged in recesses 59. In a manner corresponding to the cylinder sections 54, clamping sections 46 with inwardly pointing clamping tongues 46a are provided. Said clamping sections 46 are not provided directly on the profile section 40 assigned on the inside but rather are arranged on separate metallic connecting sections 44, wherein the metallic connecting sections 44 can be pushed into grooves 48 of the profile section 40. Locking blocks 49 are integrally formed on the second profile section 40 adjacent to the grooves 48. Said locking blocks are designed and arranged in such a manner that, in the joined-together state of the profile sections 40, 50, said locking blocks engage in the recesses 59 on the second profile section 50 and thereby prevent the profile sections, when joined together, from being able to be detached from each other by the connecting sections 44 being pushed out of the grooves 48. In the region in which the clamping sections 46 and the cylinder sections 54 are joined together and are pushed through the locking blocks 49 into the recesses 59, recesses 20a are provided in the flexible sheetlike structure 20.

The manner in which the drawing-out profile of FIG. 2a is joined together is illustrated in FIG. 2b. In order to join the profile sections 40, 50 together, first of all the sheetlike structure 20 is placed onto the profile section 40 in the region of the contact surface 40a. Subsequently, the connecting web 42 of the profile section 40 is inserted into the groove 52 of the profile section 50. In this state, the connecting web 42 and the groove 52 form a type of hinge arrangement which defines a pivot axis running in the direction of the main direction of extent 2. The profile sections 40, 50 can then be pivoted in relation to each other about said pivot axis until the cylinder sections 54 are pressed through the recesses 20a in the flexible sheetlike structure 20 into the clamping sections 46. The cylinder sections 54 deflect the clamping tongues 46a there while they are being pressed into the clamping section 46. As a result, the metallic clamping tongues 46a press into the circumferential surfaces of the plastic cylinder sections and effectively prevent the cylinder sections from subsequently being pulled out of the clamping sections 46. The profile sections 40, 50 are pressed together with an actuating force which ensures that the flexible sheetlike structure 20 bears in a planar manner and under pressure against the contact surfaces 40a and 50a and is deflected in particular in the region of the deflecting thresholds 40b, 50b.

By means of the force which acts on the flexible sheetlike structure via the contact surfaces 40a, 50a and by means of the design of the sheetlike structure 20 with recesses 20a, a secure connection is ensured between the sheetlike structure 20 and the drawing-out profile 30. The labyrinth guide which is formed by the thresholds 40b, 50b on the contact surfaces 40a, 50a also contributes to this.

A second embodiment is illustrated in FIGS. 3a, 3b. In said second embodiment, two profile sections 140, 150 are again provided, the profile section 150 being designed as a C-shaped profile with grooves 152a, 152b facing each other. In a manner corresponding to said grooves 152a, 152b, the profile section 140 has external webs 142a, 142b which point in opposite directions and are spaced apart from each other in a manner corresponding to the grooves 152a, 152b. Furthermore, a deflecting section 144 which extends in the same direction as the web 142b is provided on the side of the web 142b. A groove 143 is located between the web 142b and the deflecting section 144.

In order to bring the drawing-out profile 130 together, first of all the flexible sheetlike structure 120 is placed onto the profile section 140 and pressed into the groove 143. Furthermore, in a manner not illustrated, the sheetlike structure is adhesively bonded in this placed-on position to the profile section 140 at certain points. Subsequently, the component comprising the profile section 140 and the flexible sheetlike structure 120 is pushed in the main direction of extent 2 into the profile section 150. The profile sections 140, 150 are dimensioned, with the flexible sheetlike structure 120 being incorporated, in such a manner that, in the joined-together state, they form a press fit which leads to a drawing-out profile which can only be detached with difficulty. In addition to said press fit and the welding of the sheetlike structure 120 to the profile section 140, the shaping of the accommodating space, in which the sheetlike structure 120 is located within the drawing-out profile 130, is also responsible for a high degree of stability. Owing to the quadruple deflection of the sheetlike structure at the web 142b and the deflecting section 144 by 90° in each case, high holding forces are caused, opposing the sheetlike structure being pulled out of the drawing-out profile 130.

In the embodiment of FIGS. 4a and 4b, the drawing-out profile 230 again comprises two profile sections 240, 250. Two accommodating grooves 252a, 252b are provided on the profile section 250, with a respective corresponding connecting web 242a, 242b being provided on the profile section 240. Furthermore, a locking web 254 is provided on the profile section 250, said locking web extending over the entire length of the profile section 250 and corresponding to which a locking recess 244 is provided on the inside of the profile section 240.

FIG. 4b clarifies the installation of the drawing-out profile 230. Again, first of all a flexible sheetlike structure 220 is arranged on the one profile section 240, with adhesive bonding or welding to the profile section 240 optionally also being possible. Subsequently, the profile section 250 is pushed in an insertion direction 4 onto the profile section 240, with the two connecting webs 242a, 242b being inserted into the corresponding grooves 252a, 252b. Since the locking web 254 is not yet level with the locking recess 244 before said installation step is finished, an elastic deformation of the profile section 240 and/or of the profile section 250 occurs. Only when, over the course of the profile section 250 being pushed onto the profile section 240, the end position is reached does the locking web 254 latch into the locking recess 244 such that a separation of the profile sections 240, 250 counter to the pushing-in direction 4 is subsequently no longer possible.

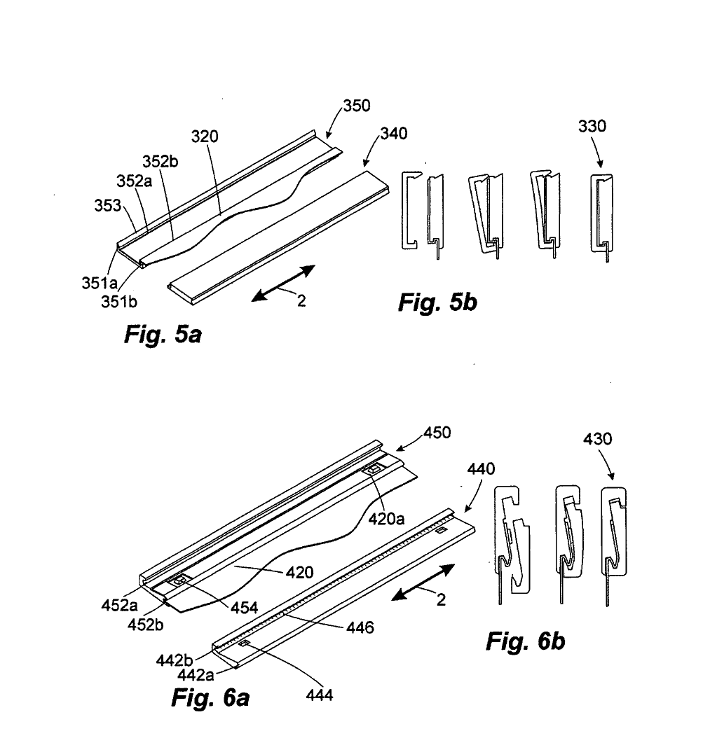

FIGS. 5a and 5b show a further embodiment of a drawing-out profile 330 according to the invention. In this embodiment, the first profile section 350 is again of approximately C-shaped design. However, in a departure from the profile section 150 of the drawing-out profile 130, one of the limbs 351a, 351b, which each define a groove 352a, 352b, has an entry slope 353 of a latching lug. After the flexible sheetlike structure 320 is placed into the C-profile 350, said entry slope 353 permits the second profile section 340 to first of all be inserted into the groove 352b and then to be pivoted until, after the limb 351a is deflected, the profile section 240 is also snapped into the second groove 352a by means of the entry slope 353.

The embodiment of FIGS. 6a and 6b largely corresponds to the embodiment of FIGS. 4a and 4b. Again, one of the two profile sections 440, 450 of the drawing-out profile 430 has two grooves 452a, 452b which are open in an identical direction. Counter to said direction, the second profile section 440 can be pressed by means of two connecting webs 442a, 442b provided on it into said grooves. As also in the embodiment of FIGS. 4a and 4b, locking connecting elements 444, 454 are provided and, in the fully pushed-in state, produce an additional connection between the profile sections 440, 450. Said locking connecting means comprise recesses 444 on sides of the profile section 440 and locking bumps 454 on sides of the profile section 450. In the region of the locking connecting means 444, 454, the flexible sheetlike structure 420 to be placed between the profile sections 440, 450 is provided with recesses 420a.

In a departure from the embodiment of FIGS. 4a and 4b, penetrating pins 446 are provided on the connecting web 442b, said penetrating pins pressing into the flexible sheetlike structure over the course of the profile sections 440, 450 being fitted together, and therefore forming an additional means of securing against the flexible sheetlike structure 420 being inadvertently pulled out of the drawing-out profile 430.

1. Drawing-out profile (30; 130; 230; 330; 430) for a window blind of a vehicle, with two profile sections (40, 50; 140, 150; 240, 250; 340, 350; 440, 450) which extend in a main direction of extent (2) and can be connected to each other enclosing a preferably flexible sheetlike structure (20; 120; 220; 320; 420) of the window blind, wherein contact surfaces (40a, 50a) of the two profile sections bound an accommodating space for accommodating an end section of the flexible sheetlike structure, characterized in that the profile sections can be joined together in a form-fitting or frictional manner via associated connecting means (42, 46, 49, 52, 54, 59; 142a, 142b, 152a, 152b; 242a, 242b, 244, 252a, 252b, 254, 352a, 352b, 353, 342a, 342b; 442a, 442b, 452a, 452b, 444, 454).

2. Drawing-out profile according to claim 1, characterized in that the connecting means comprise hinge connecting means (42, 52; 352b) by means of which the profile sections (40, 50; 340, 350) can be joined together during installation of the drawing-out profile (30; 330) in such a manner that they can be pivoted in relation to each other about a pivot axis preferably extending in the main direction of extent (2).

3. Drawing-out profile according to claim 1, characterized in that the connecting means comprise orthogonal connecting means (54, 46; 352a) which, by pressing the profile sections (40, 50; 340, 350) together in a direction orthogonal to the contact surfaces, can be transferred into a connected state.

4. Drawing-out profile according to claim 3, characterized in that the orthogonal connecting means (352a) comprise a latching lug (353) on one of the profile sections (350) and a latching threshold on the other profile section (340), the latching lug (353) being elastically deflectable during the pressing-together operation such that it can latch behind the latching threshold.

5. Drawing-out profile according to claim 4, characterized in that the latching lug (353) is arranged and designed in such a manner that it is elastically deflected during the pressing-together operation by the latching threshold in the direction or counter to the direction of the hinge connecting means.

6. Drawing-out profile according to claim 3, characterized in that the orthogonal connecting means have:
on one of the profile sections (50) a cylindrical section (54) which extends in the direction of a surface normal of the contact surface (50a) of the profile section with the other profile section (40), and
on the other profile section (40) at least two deflectable clamping tongues (46a) which are directed toward each other and are arranged and designed in such a manner that an accommodating space which is smaller than the cross section of the cylindrical section (54) is formed between the clamping tongues (46a) in an undeflected state.

7. Drawing-out profile according to claim 1, characterized in that the connecting means have sliding-guide connecting means (142a, 142b, 152a, 152b; 242a, 242b, 252a, 252b; 442a, 442b, 452a, 452b) which permit the one profile section (140; 240; 440) to be pushed into the other profile section (150; 250; 450) in the plane of the contact surfaces, the sliding-guide connecting means preferably being designed in such a manner that they form a press fit in the pushed-in state.

8. Drawing-out profile according to claim 7, characterized in that the sliding-guide connecting means (242a, 242b, 252a, 252b; 442a, 442b, 452a, 452b) are designed in such a manner that one of the profile sections (240; 440) can be pushed into the other profile section (250; 450) in a pushing-in direction which differs from the main direction of extent (2), preferably in a pushing-in direction which is orthogonal to the main direction of extent. (2).

9. Drawing-out profile according to claim 8, characterized in that the sliding-guide connecting means have:
two receptacles (252a, 252b; 452a, 452b) which are open in the pushing-in direction (4) or counter to the pushing-in direction (4) and which are spaced apart from each other in the pushing-in direction (4), and
two insertion sections (242a, 242b; 442a, 442b) for accommodating in the receptacles.

10. Drawing-out profile according to claim 9, characterized in that the receptacles (252a, 252b; 452a, 452b) are provided on one of the profile sections and are designed such that they are open in the same direction, and in that the insertion sections (242a, 242b; 442a, 442b) are provided on the other profile section.

11. Drawing-out profile according to claim 7, characterized in that the sliding-guide connecting means (142a, 142b, 152a, 152b) are designed in such a manner that one of the profile sections (140) can be pushed in the main direction of extent (2) into the other profile section (150).

12. Drawing-out profile according to claim 11, characterized in that the sliding-guide connecting means have:
on one of the profile sections (150) two grooves (152a, 152b) which extend in the main direction of extent and the open sides of which point in opposite directions, on the other profile section (140) engagement sections (142a, 142b) for accommodating in the grooves (152a, 152b).

13. Drawing-out profile according to claim 12, characterized in that the grooves and the engagement sections each have at least two groove sections or engagement sections which are aligned with each other, with there being a respective spacing between the groove sections in the main direction of extent, the length of which spacing is greater than or equal to the length of the engagement sections.

14. Drawing-out profile according to claim 7, characterized in that the sliding-guide connecting means have:
on one of the profile sections (240; 440) a locking recess (244; 444) which is open in the direction of the other profile section (250; 450), and
on the other profile section (250; 450) a locking section (254; 454) for accommodating in the locking recess (244; 444),
the locking recess and the locking section being arranged in such a manner that the locking section can latch into the locking recess as soon as the one profile section is fully pushed into the other profile section.

15. Drawing-out profile according to claim 1, characterized in that at least one part of the connecting means is connected integrally to the associated profile section.

16. Drawing-out profile according to claim 1, characterized in that at least one part of the connecting means (46) is provided on at least one separate connecting section (44), the connecting section (44) being designed such that it can be connected to the profile section (40) assigned to said part of the connecting means.

17. Drawing-out profile according to claim 15, characterized in that the separate connecting section (44) can be fastened to the associated profile section (40) by a sliding guide (44a, 48), the sliding guide (44a, 48) preferably being designed in such a manner that the connecting section (44) can be pushed into the profile section (40) in the plane of the contact surfaces (40a) and orthogonally to the main direction of extent (2).

18. Drawing-out profile according to claim 16, characterized in that the profile sections (40, 50) are manufactured from plastic, and the separate connecting section (44) is preferably manufactured from metal.

19. Drawing-out profile according to claim 1, characterized in that the contact surfaces (40a, 50a) are shaped in such a manner that the cross section of the accommodating space, which is arranged between them, for the sheetlike structure (20) has at least one change in direction, preferably two or more changes in direction, with the changes in direction being more than 45°, preferably 90° or more.

20. Drawing-out profile according to claim 1, characterized in that penetrating sections (446) which extend into the accommodating space for the sheetlike structure (420) are provided on at least one of the profile sections (440).

21. Shading system, comprising a
sheetlike structure (20) and
a drawing-out profile (30) according to claim 1,
the drawing-out profile (30) being connected fixedly to the sheetlike structure (20) at the end thereof by enclosing the sheetlike structure.

22. Shading system according to claim 21, characterized in that the sheetlike structure (20) has recesses (20a) in the region of connecting means (54, 46, 49) of the drawing-out profile.

23. Shading system according to claim 21, characterized in that the sheetlike structure is connected to one of the profile sections with a cohesive material joint, preferably by means of an adhesive connection or a welding connection.
